(19) United States
(12) Patent Application Publication
(10) Pub. No.: US 2013/0331887 A1
(43) Pub. Date: Dec. 12, 2013

(54) Pacifier with protective shield

(71) Applicant: Narayanan M. Subramanian, Marietta, GA (US)

(72) Inventor: Narayanan M. Subramanian, Marietta, GA (US)

(21) Appl. No.: 13/909,130

(22) Filed: Jun. 4, 2013

Related U.S. Application Data
(60) Provisional application No. 61/657,865, filed on Jun. 10, 2012.

(51) Int. Cl. A61J 17/00

(52) U.S. Cl. CPC A61J 17/00
USPC 606/236

(57) ABSTRACT

A pacifier with a nipple shield around the nipple to protect the nipple from dirt when it falls from the mouth of the baby.

### PRIORITY CLAIM

This patent application claims priority from provisional U.S. patent application entitled “Pacifier with protective shield” having application No. 61/657,865 filed on Jun. 10, 2012, which is incorporated herein by reference.

### FIELD OF INVENTION

The present invention relates to pacifiers and more particularly to pacifiers with a protective shield to protect the nipple from dirt when the pacifier falls from the mouth of a baby.

### BACKGROUND OF INVENTION

Parents provide babies with pacifiers to keep them from crying. The problem with the pacifier is that when the baby drops it, the nipple portion of the pacifier gets dirty and parents have to be vigilant enough to replace it with a clean one before the baby pops it back in the mouth. To protect the nipple from getting dirty, multiple inventions have been made. Some of them are U.S. Pat. Nos. 4,819,641, 4,878,496, 5,156,617, 5,578,058, and 7,311,721. The problem with these inventions is that it is difficult to clean and dry the pacifier. Some of these inventions are more complicated to manufacture as well. Because of these reasons they have not become popular in the marketplace. The current invention overcomes these problems.

### SUMMARY OF INVENTION

The primary objective of the present invention is to make the pacifier with a nipple shield so that the nipple is protected when the pacifier falls from the mouth of the baby.

Another objective of the present invention is to make the design simple so that it is easy for parents to maintain the pacifier during and after sterilization.

A third objective is to make the product, cost effective for parents to buy and use.

A fourth objective is to make it easy to manufacture the unit.

The foregoing objectives are attained by having a pacifier with a shield around the nipple, the shield being made of a thin, flexible material that retains its shape when not pressed.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is the prior art of a pacifier.

FIG. 2 is the side view of a first embodiment with the integrated mouth guard means protecting the nipple means when the pacifier is not in use.

FIG. 3 is the perspective view of the first embodiment when the pacifier is not in use.

FIG. 4 is the side view of the first embodiment with the integrated mouth guard means pressed down when the pacifier is in use.

FIG. 5 is a perspective view of the first embodiment with the integrated mouth guard means pressed down when the pacifier is in use.

FIG. 6 is a perspective view of a second embodiment showing the pacifier protector means.

FIG. 7 is the top view of the second embodiment of the pacifier protector means.

FIG. 8 is the side view of the second embodiment of the pacifier protector means.

FIG. 9 is a perspective view of the pacifier protector means attached to the top of the mouth guard of prior art pacifier.

FIG. 10 is a perspective view of the pacifier protector means attached to the bottom of the mouth guard of prior art pacifier.

### DETAILED DESCRIPTION OF THE INVENTION

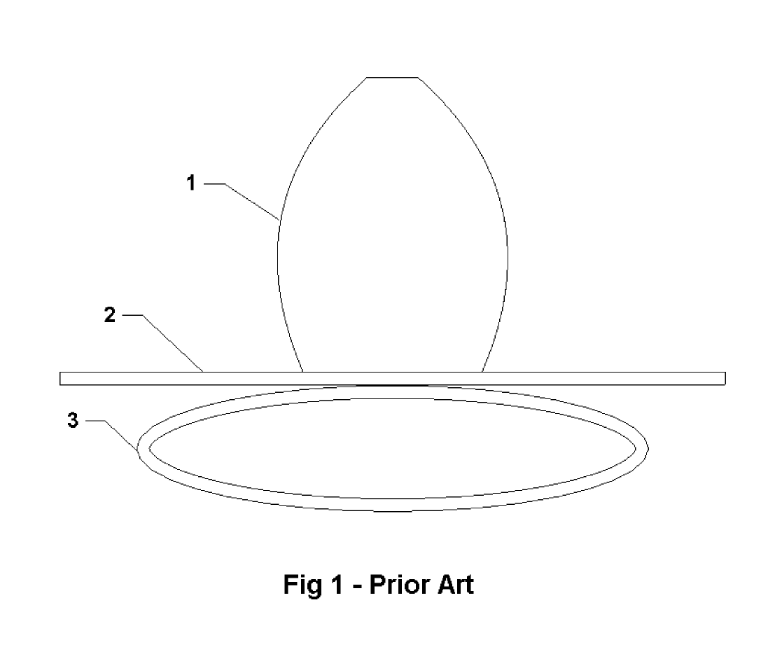

FIG. 1 shows the prior art which consists of a nipple, 1, at the base of which is attached a mouth guard, 2. A handle, 3, is attached to mouth guard 2 on the side opposite the nipple.

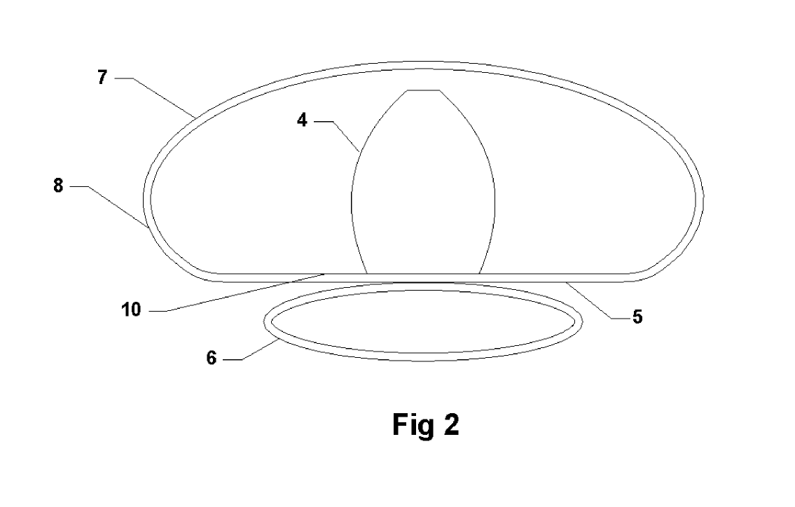

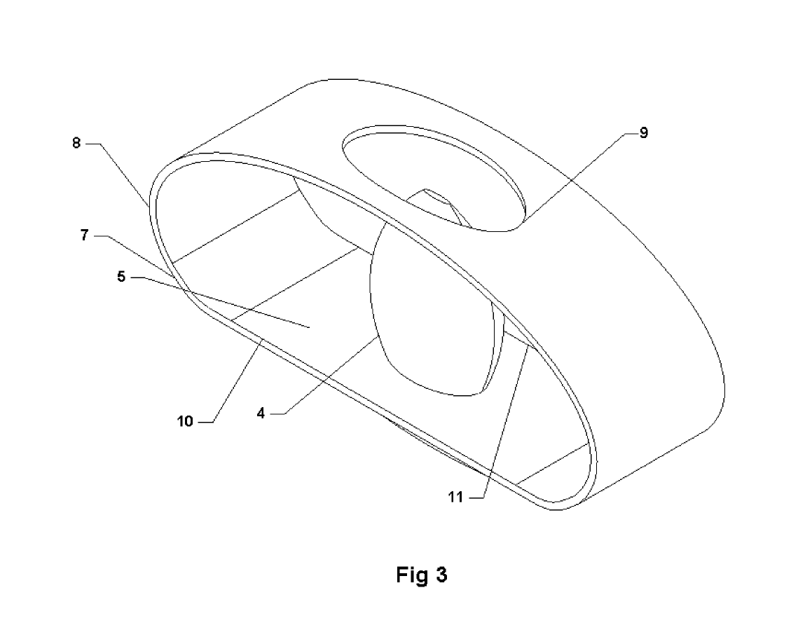

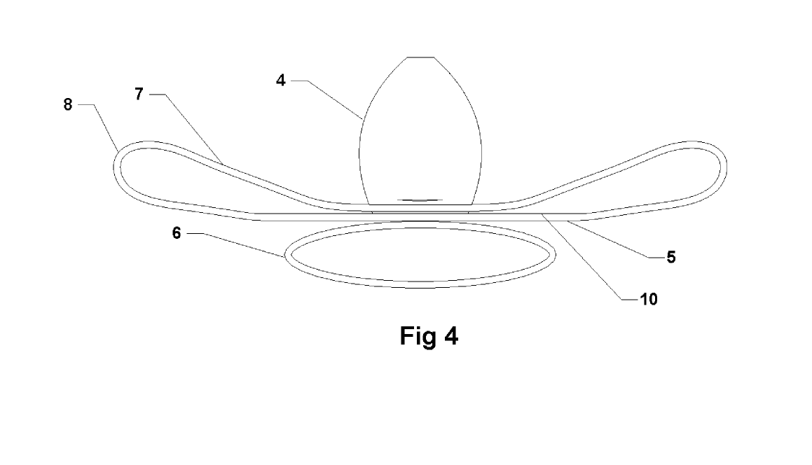

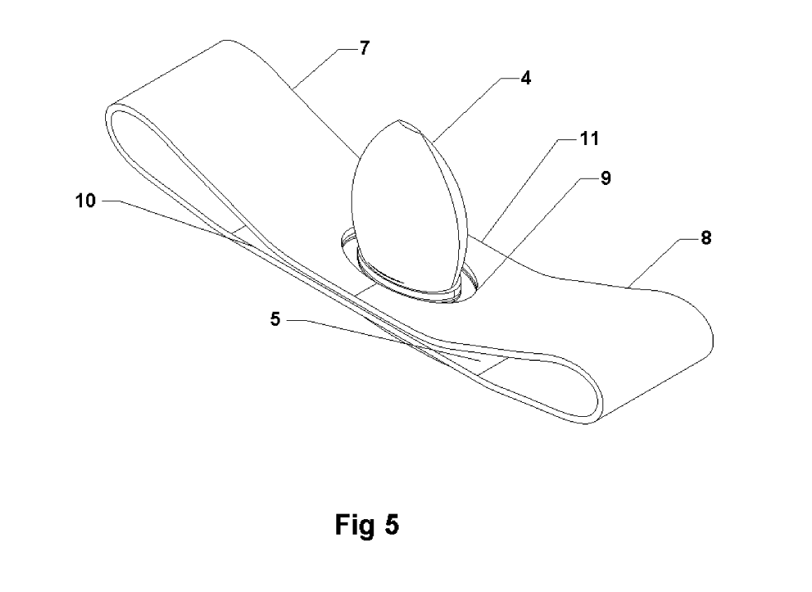

FIG. 2 through FIG. 5 show a first embodiment of the current invention. Here the pacifier comprises of an integrated mouth guard means, 7, with a nipple means, 4, attached to a first side of said integrated mouth guard means, 7. A handle means, 6, is attached to a second side of said integrated mouth guard means. Integrated mouth guard means comprises of a mouth guard means, 5, integrated with nipple shield means, 8. Nipple shield means 8 has a hole, 9, that is big enough for said nipple means to pass through easily when said nipple shield means is pressed down as shown in FIG. 4 and FIG. 5. The center of said hole, 9, is sufficiently on the same axis as the center of said nipple means. Said nipple shield means, 8, is made of flexible material that can be pressed down with a sufficiently small downward force that the baby's mouth can exert against said nipple shield means without hurting the baby's mouth when in use. This flexible material also will have sufficient stiffness that it can come back to its original manufactured shape when not pressed. While the contour of said nipple shield means can be anything as long as it is able to fulfill the need of protecting the nipple means when not in use, it is preferable to have the contour be sufficiently the same as mouth guard means so that , when pressed against said mouth guard means by the baby's mouth, said nipple shield means is not in the way of baby's nose. The linear length of said nipple shield means is such that said integrated mouth guard means encloses said nipple means within it when said nipple shield means is not pressed. This can be seen in FIG. 2 and FIG. 3. Said integrated mouth guard means has a third side, 10, and a fourth side, 11, that are open as shown in FIG. 3. This makes it very convenient to clean and dry the pacifier.

Normally, the nipple shield means will retain its shape as shown in FIG. 2 and FIG. 3. When the pacifier is in the mouth of the baby, said nipple shield means is pressed down such that said nipple means protrudes through said hole in said nipple shield means. This is shown in FIG. 4 and FIG. 5. Since the stiffness of said nipple shield means material is low, the baby need not apply extra force to keep the nipple shield means pressed against said mouth guard means of said integrated mouth guard means. When the pacifier falls from the mouth of the baby or when it is removed, the stiffness of said nipple shield means material acts as a spring to bring said nipple shield means back to its original shape as shown in FIG. 2 and FIG. 3. Because the nipple shield means springs back immediately, nipple means does not come in contact with material on the floor. Hence the pacifier can be reused immediately without sterilization. Since said third side and said fourth side are open, it is very convenient to clean and dry the pacifier.

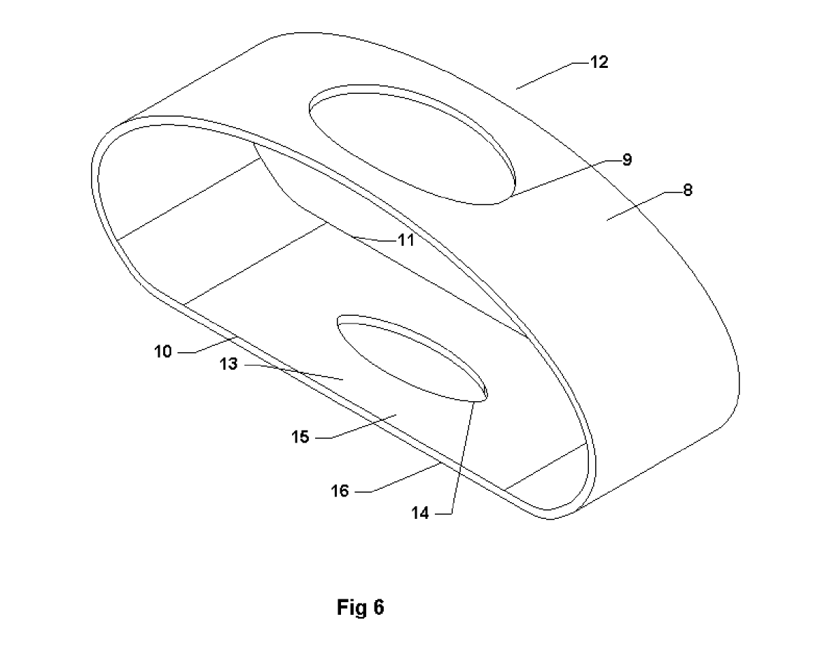

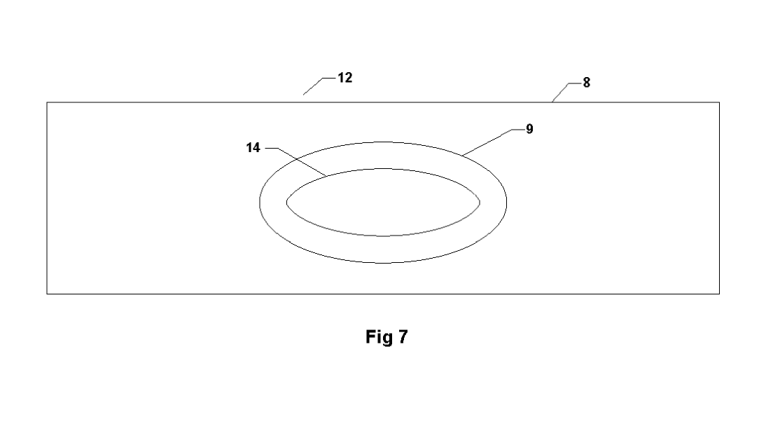

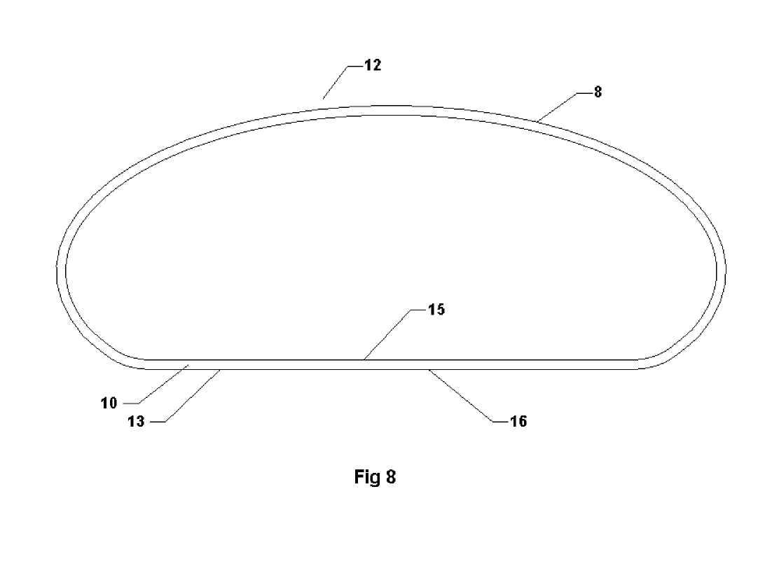

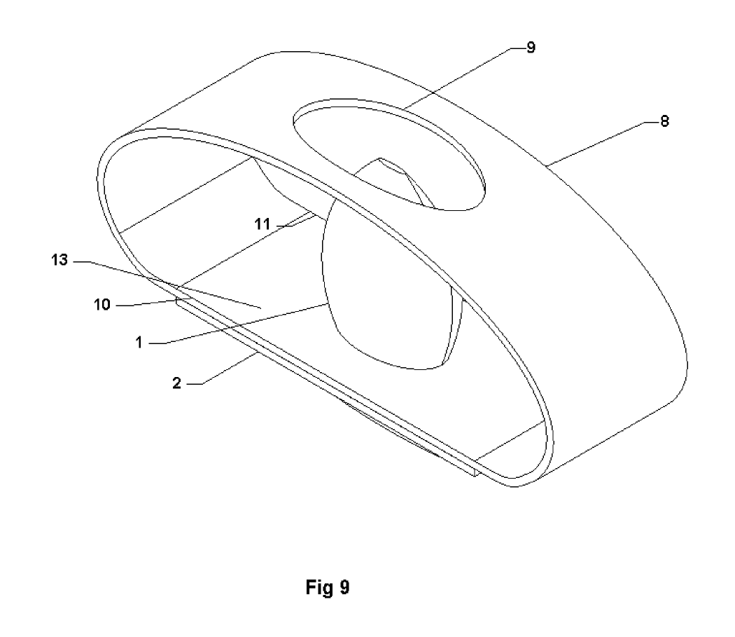

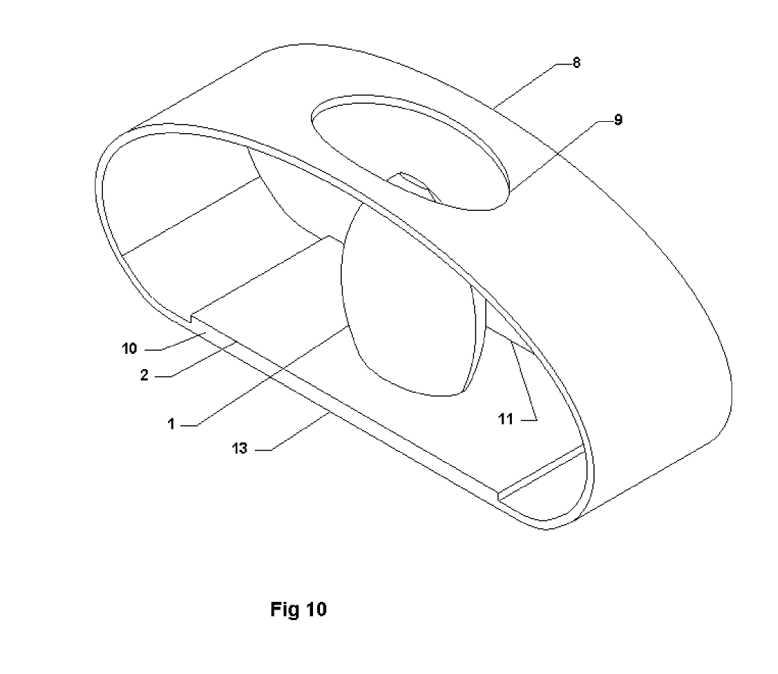

FIG. 6 through FIG. 8 show a second embodiment of the current invention. Here a pacifier protector means, 12, is an oval shaped band though the cross-section can be circular, rectangular or a combination of any of them. Pacifier protector means, 12, comprises of a base means, 13, and a nipple shield means, 8. Said base means has a top side, 15, and a bottom side, 16 and a base hole, 14 in the middle. Nipple shield means 8 has a hole, 9, that is big enough for the nipple in a pacifier to pass through easily when said nipple shield means is pressed down against said base means. An adhesive is applied to either the top side, 15 or the bottom side, 16 of said base means. If adhesive is applied to bottom side 16, then the parent will insert nipple, 1, of prior art pacifier from below said pacifier protector means via base hole 14 and press it so that the adhesive sticks permanently to mouth guard 2 of the pacifier. This is shown in FIG. 9. If adhesive is applied to top side 15, then the parent will insert handle, 3, of prior art pacifier from above said base means via base hole 14 and press it so that the adhesive sticks to mouth guard 2 of the pacifier. This is shown in FIG. 10. Said pacifier protector means, 12, is made of flexible material that can be pressed down with a sufficiently small downward force that the baby's mouth can exert against said nipple shield means without hurting the baby's mouth when in use. This flexible material also will have sufficient stiffness that it can come back to its original manufactured shape when not pressed. While the contour of said pacifier protector means can be anything as long as it is able to fulfill the need of protecting the nipple of a pacifier when not in use, it is preferable to have the contour be sufficiently the same as mouth guard of the pacifier so that , when pressed against the mouth guard by the baby's mouth, said nipple shield means is not in the way of baby's nose. The linear length of said nipple shield means is such that said pacifier protector means encloses the nipple within it when said nipple shield means is not pressed. Said pacifier protector means has a third side, 10, and a fourth side, 11 that is open, as shown in FIG. 6, FIG. 8, FIG. 9 and FIG. 10. This makes it very convenient to clean and dry the pacifier.

What is claimed is:

1. A pacifier comprising:
1. a mouth guard means and a nipple shield means together forming an integrated mouth guard means;
2. a nipple means protruding from a first side of said mouth guard means;
3. a handle means attached to a second side of said mouth guard means.

2. A pacifier of claim 1 wherein said nipple shield means covers top of said nipple means to protect it from dirt.

3. A pacifier of claim 2 wherein said nipple shield means has a sufficiently large hole for said nipple means to protrude there through when downward force is applied to said nipple shield means.

4. A pacifier of claim 3 wherein said nipple shield means is flexible enough to be pressed against said mouth guard means when a small downward force is applied to said nipple shield means; said downward force small enough to be applied by a baby's mouth while using the pacifier.

5. A pacifier of claim 4 wherein said nipple shield means is stiff enough to attain original shape when said downward force is removed.

6. A pacifier of claim 5 wherein said nipple shield means contour matches said mouth guard means contour when pressed against said mouth guard means so as not to be in the way of the baby's nose when in use.

7. A pacifier of claim 5 wherein said nipple shield means is open on atleast one side for ease of cleaning and aeration.

8. A pacifier protector means comprising:
1. a base means with with a top side and a bottom side;
2. a nipple shield means formed contiguously from said base means to cover nipple of a pacifier when said base means is fixedly attached to mouth guard of the pacifier.

9. A pacifier protector means of claim 8 wherein said nipple shield means has a sufficiently large hole for pacifier nipple to protrude there through when downward force is applied to said nipple shield means.

10. A pacifier protector means of claim 9 wherein said nipple shield means is flexible enough to be pressed against said base means when a small downward force is applied to said nipple shield means; said downward force small enough to be applied by a baby's mouth while using the pacifier.

11. A pacifier protector means of claim 10 wherein said nipple shield means is stiff enough to attain original shape when said downward force is removed.

12. A pacifier protector means of claim 11 wherein said nipple shield means is open on atleast one side for ease of cleaning and aeration.

13. A pacifier protector means of claim 12 wherein said base means has a base hole large enough for pacifier nipple to pass through.

14. A pacifier protector means of claim 12 wherein said base means has a base hole large enough for pacifier handle to pass through.

15. A pacifier protector means of claim 14 wherein said top side of said base means has an adhesive coating.

16. A pacifier protector means of claim 13 wherein said bottom side of said base means has an adhesive coating.
